(19) United States
(12) Patent Application Publication
(10) Pub. No.: US 2007/0040795 A1
(43) Pub. Date: Feb. 22, 2007

(54) Liquid crystal display device and method of driving the same

(76) Inventors: Hyun-Su Lee, Anyang-si (KR); Jae-Min Ha, Yongin-si (KR)

Correspondence Address: CANTOR COLBURN, LLP, 55 GRIFFIN ROAD SOUTH, BLOOMFIELD, CT, 06002, US

(21) Appl. No.: 11/507,681

(22) Filed: Aug. 22, 2006

(30) Foreign Application Priority Data
Aug. 22, 2005 (KR) 2005-76614

(51) Int. Cl. G09G 3/36

(52) U.S. Cl. 345/100

(57) ABSTRACT

A liquid crystal display (“LCD”) device includes an LCD panel, a data driver and a gate driver. The LCD panel includes a first pixel section and a second pixel section formed in regions defined by a adjacent gate lines and adjacent data lines. The first pixel section is electrically charged at a first time point and the second pixel section is electrically charged at a second time point later than the first time point. The data driver provides the data lines with data voltages. The gate driver applies a first gate signal to the first pixel section, and a second gate signal having at least one different characteristic from that of the first gate signal to the second pixel section. Therefore, vertical flickering may be prevented in the LCD device.

This application claims priority to Korean Patent Application No. 2005-76614, filed on Aug. 22, 2005 and all the benefits accruing therefrom under 35 U.S.C. §119, and the contents of which in its entirety are herein incorporated by reference.

### BACKGROUND OF THE INVENTION

1. Field of the Invention

The present invention relates to a liquid crystal display (“LCD”) device and a method of driving the LCD device. More particularly, the present invention relates to an LCD device capable of improving display quality and a method of driving the LCD device.

2. Description of the Related Art

In general, a liquid crystal display (“LCD”) device displays images using optical and electrical properties of liquid crystal, such as an anisotropic refractive index, an anisotropic dielectric constant, etc. The LCD device has characteristics, for example, lighter weight structure, lower power consumption, lower driving voltage, etc., in comparison with a display device such as a cathode ray tube (“CRT”), a plasma display panel (“PDP”) and so on.

In the LCD device, an amplitude of a signal voltage that is transferred to liquid crystal molecules, in a liquid crystal panel of the LCD device, through a data line is controlled by a gate voltage applied from the gate electrode. The data voltage changes an arrangement of the liquid crystal molecules, so that various gray levels are displayed in the LCD device.

The LCD device includes a source driving integrated circuit (“IC”), a source printed circuit board (“PCB”) driving the source driving IC, a gate driving IC, and a gate PCB driving the gate driving IC. With increased usage of the LCD device, various efforts for reducing the number of source driving ICs are being made to lower manufacturing costs and to enhance driving efficiency.

For example, in order to reduce the number of source driving ICs, a half-reduced data line structure may be applied to the LCD device. The half-reduced data line structure includes a first pixel and a second pixel formed in one area that is divided by data lines adjacent to each other and gate lines adjacent to each other. The first and second pixels are charged at different times with respect to each other.

In the half-reduced data line structure of the LCD device, when the second pixel is charged after the first pixel is charged, a charging quantity of the second pixel is changed due to a coupling capacitance between the first pixel and the second pixel.

The difference of charging quantity induces vertical flickering that is displayed in a display area of the liquid crystal panel.

### BRIEF SUMMARY OF THE INVENTION

The present invention provides a liquid crystal display (“LCD”) device capable of improving display quality by preventing flickering induced by a change of charging quantity in a half-reduced data line structure.

The present invention also provides a method of driving the above-mentioned LCD device.

In exemplary embodiments of the present invention, the LCD device includes an LCD panel, a data driver, and a gate driver. The LCD panel includes a first pixel section and a second pixel section respectively formed in corresponding regions defined by a plurality of gate lines adjacent to each other and a plurality of data lines adjacent to each other. The first pixel section is electrically charged at a first time point and the second pixel section is electrically charged at a second time point later than the first time point. The data driver provides the data lines with data voltages. The gate driver applies a first gate signal to the first pixel section, and a second gate signal, having at least one different characteristic from that of the first gate signal, to the second pixel section.

The data driver may apply a first data signal to the first pixel section, and a second data signal, having an opposite polarity to that of the first data signal, to the second pixel section, in which case an amplitude of the first gate signal may be greater than an amplitude of the second gate signal. Alternatively, a pulse width of the first gate signal may be wider than a pulse width of the second gate signal.

The data driver may apply a first data signal to the first pixel section, and a second data signal, having a same polarity as that of the first data signal, to the second pixel section, in which case an amplitude of the first gate signal may be smaller than an amplitude of the second gate signal. Alternatively, a pulse width of the first gate signal may be narrower than a pulse width of the second gate signal.

In other exemplary embodiments of the present invention, there is provided a method of driving the LCD device, such as the above-described LCD device. In the method, data voltages are outputted to the data lines. A first gate signal is outputted to a gate line electrically connected to the first pixel section. Then, a second gate signal having at least one different characteristic from that of the first gate signal is outputted to a gate line electrically connected to the second pixel section after the first gate signal is applied to the gate line electrically connected to the first pixel section.

The data voltages may include a first data signal applied to the first pixel section, and a second data signal, having an opposite polarity to that of the first data signal, applied to the second pixel section. Then, an amplitude of the first gate signal may be greater than an amplitude of the second gate signal. Alternatively, a pulse width of the first gate signal may be wider than a pulse width of the second gate signal.

The data voltages may include a first data signal applied to the first pixel section, and a second data signal, having a same polarity as that of the first data signal, applied to the second pixel section. Then, an amplitude of the first gate signal may be smaller than an amplitude of the second gate signal. Alternatively, a pulse width of the first gate signal may be narrower than a pulse width of the second gate signal.

According to the LCD device and the method of driving the LCD device, vertical flickering may be prevented in the LCD device.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram illustrating an exemplary liquid crystal display (“LCD”) device according to an exemplary embodiment of the present invention;

FIG. 2 is a waveform diagram illustrating exemplary gate signals outputted from the exemplary first and second gate drivers in FIG. 1;

FIG. 3 is a layout diagram illustrating an exemplary pixel section that is formed on the exemplary LCD panel in FIG. 1;

FIG. 4 is an equivalent circuit diagram illustrating an exemplary pixel section of the exemplary LCD panel in FIG. 1;

FIG. 5 is a circuit diagram illustrating an exemplary pixel section of the exemplary LCD device in FIG. 1;

FIG. 6 is a waveform diagram illustrating exemplary gate voltages and exemplary data voltages in FIG. 5;

FIG. 7 is a waveform diagram illustrating charging quantity characteristics of exemplary data voltages in FIG. 5;

FIG. 8 is a block diagram illustrating an exemplary LCD device according to another exemplary embodiment of the present invention;

FIG. 9 is a waveform diagram illustrating exemplary gate signals outputted from exemplary first and second gate drivers in FIG. 8;

FIG. 10 is a circuit diagram illustrating an exemplary pixel element section of the exemplary LCD device in FIG. 8;

FIG. 11 is a waveform diagram illustrating exemplary gate voltages and exemplary data voltages in FIG. 10; and

FIG. 12 is a waveform diagram illustrating charging quantity characteristics of exemplary data voltages in FIG. 10.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly, formal sense unless expressly so defined herein.

Hereinafter, the present invention will be explained in detail with reference to the accompanying drawings. Some exemplary embodiments of the present invention will be explained based on a structure of having first and second pixel element sections where data signals of the same polarity are applied thereto. When data signals of opposite polarity are applied to the first and second pixel element sections, the gate signals applied to the first and second pixel element sections are opposite.

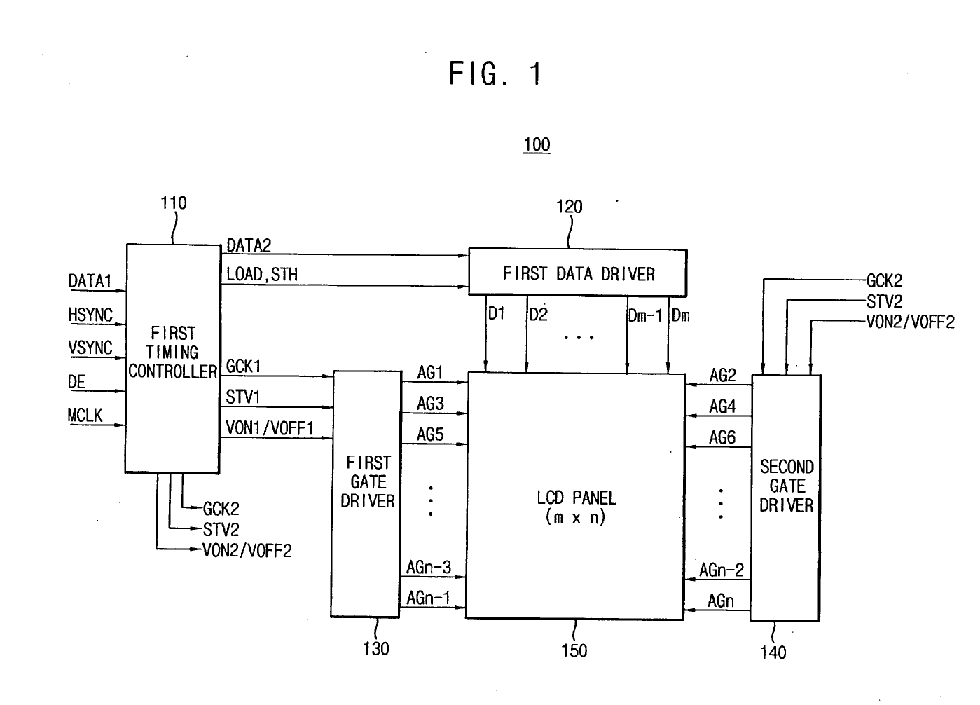

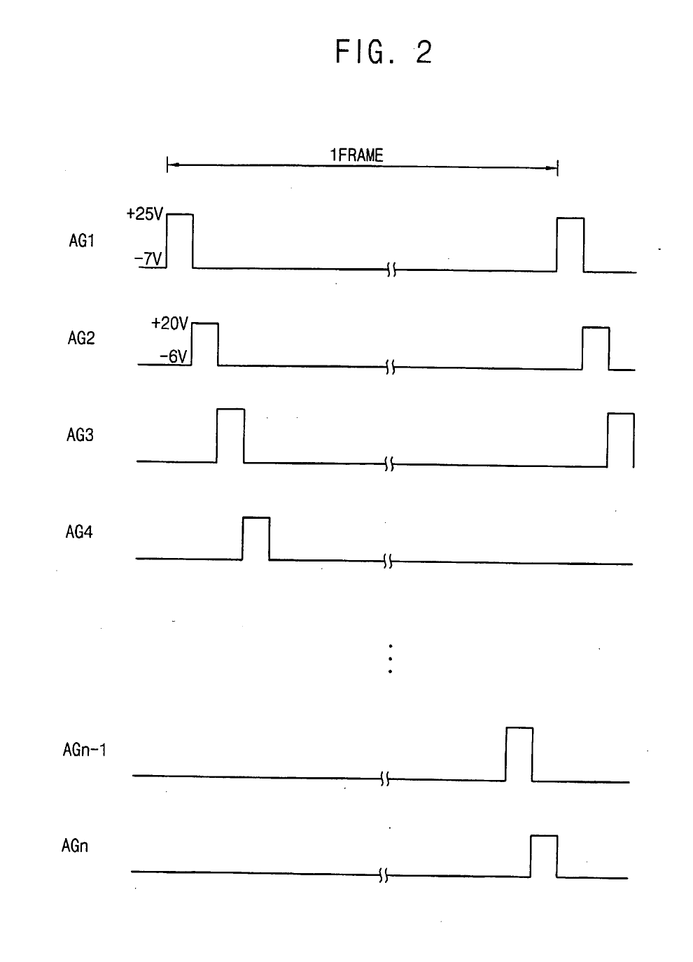

FIG. 1 is a block diagram illustrating an exemplary liquid crystal display (“LCD” ) device according to an exemplary embodiment of the present invention. FIG. 2 is a waveform diagram illustrating exemplary gate signals outputted from the exemplary first and second gate drivers in FIG. 1.

Referring to FIGS. 1 and 2, an LCD device 100 includes a first timing controller 110, a first data driver 120, a first gate driver 130, a second gate driver 140, and an LCD panel 150.

The first timing controller 110 receives a first data signal DATA1, various synchronizing signals HYNC and VSYNC, a data enable signal DE, and a main clock signal MCLK from an external device. The first timing controller 110 outputs a second data signal DATA2, and a data drive signal to the first data driver 120. The data drive signal includes a load signal LOAD and a horizontal start signal STH.

The first timing controller 110 also outputs a first gate drive signal and a first gate voltage to the first gate driver 130, and outputs a second gate drive signal and a second gate voltage to the second gate driver 140. The first gate drive signal includes a first gate clock signal GCK1 and a first vertical start signal STV1. The first gate voltage includes a first gate-on voltage VON1 and a first gate-off voltage VOFF1. The second gate drive signal includes a second gate clock signal GCK2 and a second vertical start signal STV2. The second gate voltage includes a second gate-on voltage VON2 and a second gate-off voltage VOFF2. The first vertical start signal STV1 precedes the second vertical start signal STV2. Therefore, the second gate driver 140 is activated after the first gate driver 130 is activated. A rising edge of the first vertical start signal STV1 and a rising edge of the second vertical start signal STV2 are separated by about a 1 H time interval, or a falling edge of the first vertical start signal STV1 and a falling edge of the second vertical start signal STV2 are separated by a 1 H time interval.

The second gate-on/off voltages VON2/VOFF2 may be at levels at which a switching element of the LCD panel 150 is normally turned on/off. A thin-film transistor (“TFT”) may be employed as the switching element.

In one example, the first gate-off voltage VOFF1 is substantially equal to the second gate-off voltage VOFF2, and the first gate-on voltage VON1 is higher than the second gate-on voltage VON2. In such an example, the first gate-on voltage VON1 is at a higher level than what is required to turn on a TFT of the LCD panel 150.

Alternatively, the first gate-on voltage VON1 is relatively higher than the second gate-on voltage VON2, and the first gate-off voltage VOFF1 is relatively lower than the second gate-off voltage VOFF2. For example, when the second gate-off voltage VOFF2 is about −6V, the first gate-off voltage VOFF1 may be about −7V, and when the second gate-on voltage VON2 is about 20V, the first gate-on voltage VON1 may be about 25V.

When the first data driver 120 receives the second data signal DATA2 from the first timing controller 110, the first data driver 120 changes the second data signal DATA2 into a data voltage that corresponds to a gray-scale voltage. Then, the first data driver 120 provides data lines of the LCD panel 150 with the changed data voltages D1, D2, . . . , Dm, wherein ‘m’ represents an integer.

The first gate driver 130 sequentially provides odd-numbered gate lines of the LCD panel 150 with odd-numbered gate signals AG1, AG3, . . . , AGn-3 and AGn-1 activating the odd-numbered gate lines in response to the first gate drive signal GCK1 and STV1, where ‘n’ represents an even number.

The second gate driver 140 sequentially provides even-numbered gate lines of the LCD panel 150 with even-numbered gate signals AG2, AG4, . . . , AGn-2 and AGn in response to the second gate drive signal GCK2 and STV2, activating the even-numbered gate lines. The odd-numbered gate signals AG1, AG3, . . . , AGn-3 and AGn-1 and the even-numbered gate signals AG2, AG4, . . . , AGn-2 and AGn are alternately outputted to the LCD panel 150.

In one exemplary embodiment, a level of the odd-numbered gate signals AG1, AG3, . . . , AGn-3 and AGn-1 is higher than a level of the even-numbered gate signals AG2, AG4, . . . , AGn-2 and AGn. Also in one exemplary embodiment, charges applied to second pixel element sections corresponding to the even-numbered gate signals AG2, AG4, . . . , AGn-2 and AGn are opposite to charges previously stored in first pixel element sections corresponding to the odd-numbered gate signals AG1, AG3, . . . , AGn-3 and AGn-1. That is, they may have an opposite polarity. As a result, charges are easily stored in the second pixel element sections corresponding to the even-numbered gate signals AG2, AG4, . . . , AGn-2 and AGn. Therefore, the even-numbered gate signals AG2, AG4, . . . , AGn-2 and AGn have a lower level than the odd-numbered gate signals AG1, AG3, . . . , AGn-3 and AGn-1.

On the contrary, in an alternative embodiment, when charges applied to the second pixel element sections corresponding to the even-numbered gate signals AG2, AG4, . . . , AGn-2 and AGn are substantially the same as charges previously stored in first pixel element sections corresponding to the odd-numbered gate signals AG1, AG3, . . . , AGn-3 and AGn-1, such as by having the same polarity, the charges are not easily stored in the second pixel element sections corresponding to the even-numbered gate signals AG2, AG4, . . . , AGn-2 and AGn. Therefore, in this embodiment, the even-numbered gate signals AG2, AG4, . . . , AGn-2 and AGn have a higher level than the odd-numbered gate signals AG1, AG3, . . . , AGn-3 and AGn-1.

The LCD panel 150 includes a plurality of gate lines (or scan lines) extending in a first direction and transferring the gate signals (or scan signals) AG1, AG2, . . . , AGn-1 and AGn, and a plurality of data lines (or source lines) extending in a second direction substantially perpendicular to the first direction and transferring the data voltages D1, D2, . . . , Dm. The LCD panel 150 has a half-reduced data line structure, so that the LCD panel 150 has an increased number of gate lines and reduced number of data lines.

An LCD panel having the half-reduced data line structure includes the first pixel element section and the second pixel element section formed on an area defined by a plurality of gate lines adjacent to each other and a plurality of data lines adjacent to each other.

For example, as will be further described below, the first pixel element section includes a first TFT, and a first liquid crystal capacitor electrically connected to a drain electrode of the first TFT. The second pixel element section includes a second TFT and a second liquid crystal capacitor electrically connected to a drain electrode of the second TFT. A storage capacitor is electrically connected to the first and second liquid crystal capacitors, so that the first and second pixel element sections share the storage capacitor.

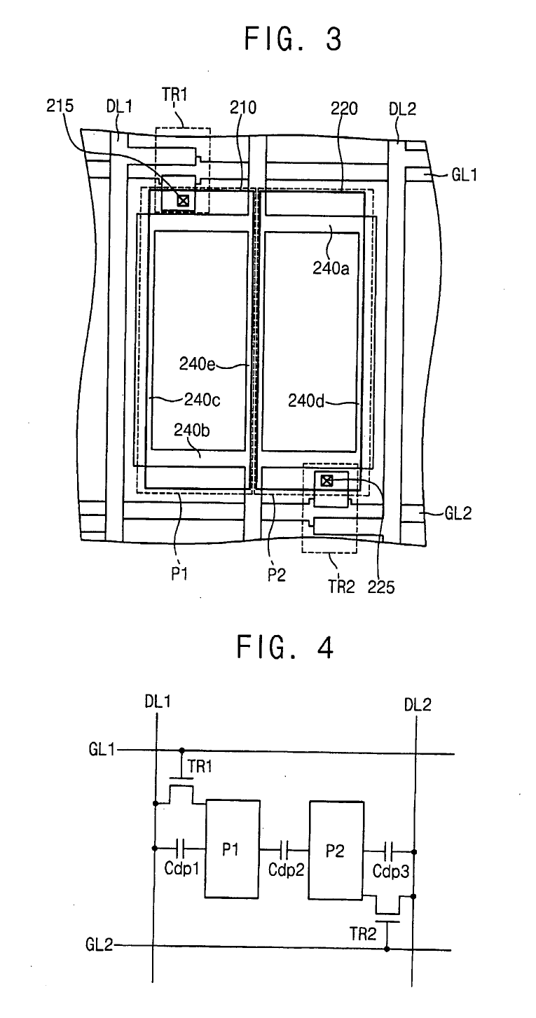

FIG. 3 is a layout diagram illustrating exemplary pixel sections that are formed on the exemplary LCD panel in FIG. 1.

Referring to FIG. 3, a first pixel element section P1 is electrically connected to a first gate line GL1, and a second pixel element section P2 is electrically connected to a second gate line GL2. The first pixel element section P1 is also electrically connected to a first data line DL1, and the second pixel element section P2 is also electrically connected to a second data line DL2.

The first pixel element section P1 includes a first TFT TR1 and a first pixel electrode 210. The first TFT TR1 includes a gate electrode extended from the first gate line GL1, a source electrode extended from the first data line DL1, and a drain electrode. The drain electrode of the first TFT TR1 is electrically connected to the first pixel electrode 210 through a first contact hole 215.

The second pixel element section P2 includes a second TFT TR2 and a second pixel electrode 220. The second TFT TR2 includes a gate electrode extended from a second gate line GL2, a source electrode extended from a second data line DL2, and a drain electrode. The drain electrode of the second TFT TR2 is electrically connected to the second pixel electrode 220 through a second contact hole 225.

Additionally, a first storage line 240a is formed at the first and second pixel element sections P1 and P2, and is extended in parallel with and adjacent to the first gate line GL1. A second storage line 240b is formed at the first and second pixel element sections P1 and P2, and is extended in parallel with and adjacent to the second gate line GL2.

A third storage line 240c that is substantially parallel with the first data line DL1 is formed at the first pixel element section P1, which electrically connects a first end portion of the first storage line 240a to a first end portion of the second storage line 240b. For example, the third storage line 240c is formed such that the third storage line 240c is partially overlapped with the first pixel electrode 210.

Also, a fourth storage line 240d that is parallel with the third storage line 240c and the second data line DL2 is formed at the second pixel element section P2, which electrically connects a second end portion of the first storage line 240a to a second end portion of the second storage line 240b. For example, the fourth storage line 240d is formed such that the fourth storage line 240d is partially overlapped with the second pixel electrode 220.

A fifth storage line 240e is formed at an adjoining area between the first and second pixel element sections P1 and P2. The fifth storage line 240e electrically connects a central portion of the first storage line 240a to a central portion of the second storage line 240b. The fifth storage line 240e is extended along a direction that is substantially parallel with the first and second data lines DL1 and DL2, and substantially parallel with the third storage line 240c and the fourth storage line 240d. For example, the fifth storage line 240e is partially overlapped with both the first pixel electrode 210 and the second pixel electrode 220. Therefore, the first pixel element section P1 and the second pixel element section P2 share the fifth storage line 240e.

A lower electrode of a storage capacitor Cst for the first pixel element section P1 is defined by portions of the first and second storage lines 240a and 240b, a portion of the third storage line 240c and a portion of the fifth storage line 240e. Also, the lower electrode of a storage capacitor Cst for the second pixel element section P2 is defined by one portion of the first and second storage lines 240a and 240b, one portion of the fourth storage line 240d and one portion of the fifth storage line 240e.

The first to fifth storage lines 240a to 240e and source and drain electrodes of the first and second TFTs TR1 and TR2 include substantially the same metal. Additionally, the first to fifth storage lines 240a to 240e and source and drain electrodes of the first and second TFTs TR1 and TR2 are formed through substantially the same process.

Accordingly, the first to fifth storage lines 240a to 240e are formed on a gate insulating layer, so that the first to fifth storage lines 240a to 240e define the lower electrode of the storage capacitor Cst. An insulating layer (not shown) is formed on the first to fifth storage lines 240a to 240e, so that the insulating layer defines a dielectric substance of the storage capacitor Cst. The first and second pixel electrodes 210 and 220 that are formed on the insulating layer (not shown) defining an upper electrode of the storage capacitor Cst.

FIG. 4 is an equivalent circuit diagram illustrating an exemplary pixel section of the exemplary LCD panel in FIG. 1.

Referring to FIG. 4, a pixel element section is formed in an area surrounded by the first and second data lines DL1 and DL2, and the first and second gate lines GL1 and GL2. The pixel element section includes a first TFT TR1, a first pixel P1 electrically connected to the first TFT TR1, a second TFT TR2, and a second pixel P2 electrically connected to the second TFT TR2.

A gate electrode, a source electrode and a drain electrode of the first TFT TR1 are electrically connected to the first gate line GL1, the first data line DL1 and the first pixel P1, respectively. A gate electrode, a source electrode and a drain electrode of the second TFT TR2 are electrically connected to the second gate line GL2, the second data line DL2 and the second pixel P2, respectively.

In FIG. 4, a structure of the pixel element section corresponds to the half-reduced data line structure having a first pixel P1 and a second pixel P2, and is electrically connected to the first data line DL1 and the second data line DL2 adjacent to each other. In the half-reduced data line structure, a first coupling capacitor Cdp1 is induced between the first data line DL1 and the first pixel P1, a second coupling capacitor Cdp2 is induced between the first pixel P1 and the second pixel P2, and a third coupling capacitor Cdp3 is induced between the second pixel P2 and the second data line DL2.

According to a conventional driving method, the first pixel P1 is charged when the first gate line GL1 is activated, and then the second pixel P2 is charged when the second gate line GL2 is activated.

In the conventional driving method, the second pixel P2 is abnormally charged due to charges stored in the first pixel P1 that has been previously charged. As a result, a difference of charging quantity between a pixel electrically connected to odd-numbered data lines and a pixel electrically connected to even-numbered data lines generates a vertical flickering displayed in a display area of the LCD panel 150.

However, according to exemplary embodiments of the present invention, a relatively pre-charged first pixel P1 is charged by a first gate signal of a relatively higher level than a relatively ordinary level, and a relatively post-charged second pixel P2 is charged by a second gate signal of a relatively ordinary level. Therefore, a vertical flickering may be prevented.

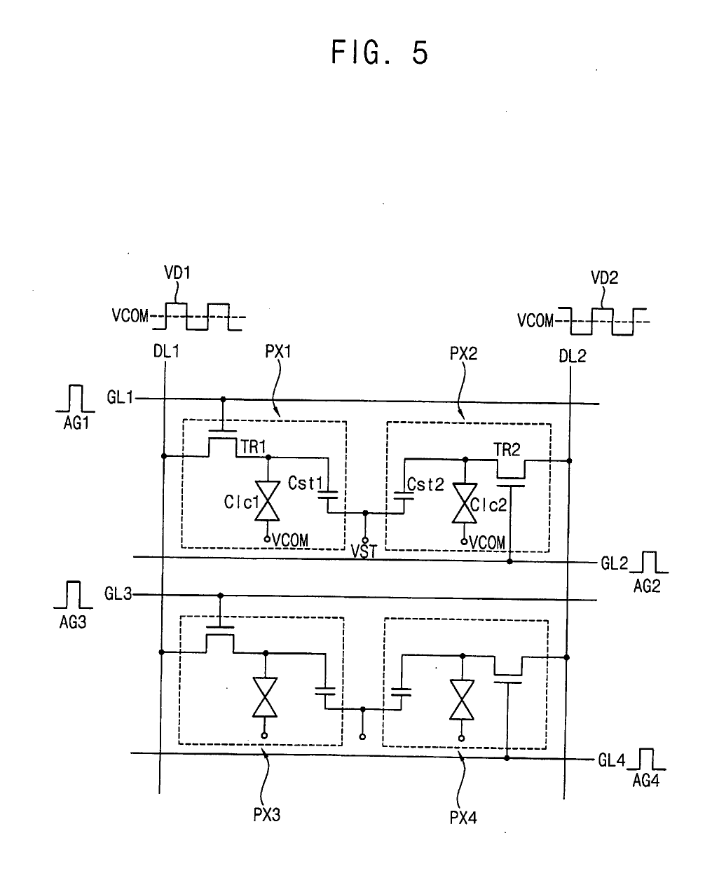

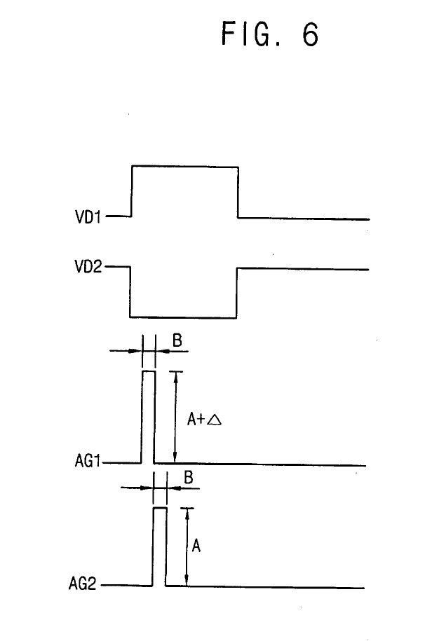

FIG. 5 is a circuit diagram illustrating an exemplary pixel section of the exemplary LCD device in FIG. 1. FIG. 6 is a waveform diagram illustrating exemplary gate voltages and exemplary data voltages in FIG. 5.

Referring to FIGS. 5 and 6, the first data voltage VD1 applied to the first data line DL1 is charged to the first pixel section PX1 in response to the first gate signal AG1 having a first level. The first pixel section PX1 includes a first TFT TR1, a first liquid crystal capacitor Clc1, and a first storage capacitor Cst1.

The first data voltage VD1 has a positive polarity with reference to a common voltage VCOM. The first gate signal AG1 is applied to the first gate line GL1, so that the first TFT TR1, which is electrically connected to the first gate line GL1, is activated. The first data voltage VD1 is charged in the first liquid crystal capacitor Clc1 and a first storage capacitor Cst1 through the first TFT TR1. The first liquid crystal capacitor Clc1 and a first storage capacitor Cst1 are electrically connected to each other. A first terminal of the first storage capacitor Cst1 is electrically connected to a drain electrode of the first TFT TR1, and a second terminal thereof is electrically connected to a VST terminal that receives a storage voltage VST.

The second data voltage VD2 applied to the second data line DL2 is charged in the second pixel section PX2 in response to the second gate signal AG2 having a second level different than the first level of the first gate signal AG1. The second pixel section PX2 includes a second TFT TR2, a second liquid crystal capacitor Clc2, and a second storage capacitor Cst2. A first terminal of the second storage capacitor Cst2 is electrically connected to a drain electrode of the second TFT TR1, and a second terminal thereof is electrically connected to the VST terminal that is also connected to the first storage capacitor Cst1. The VST terminal receives a storage voltage VST.

The second data voltage VD2 may have a negative polarity with reference to a common voltage VCOM. The second gate signal AG2 is applied to the second gate line GL2, so that the second TFT TR2, which is electrically connected to the second gate line GL2, is activated. The second data voltage VD2 is charged in the second liquid crystal capacitor Clc2 and the second storage capacitor Cst2 through the second TFT TR2. The second liquid crystal capacitor Clc2 and the second storage capacitor Cst2 are electrically connected to each other.

For example, a high level of the second gate signal AG2, having the second level, is substantially equal to a turn-on voltage of the second TFT TR2, while a high level of the first gate signal AG1, having the first level, is relatively higher than the high level of the second gate signal AG2. As shown in FIG. 6, when the second gate signal AG2 has an ‘A’ level, the first gate signal AG1 has an ‘A+Δ’ level, wherein ‘Δ’ represents positive, and the absolute value of the ‘A+Δ’ level is greater than the absolute value of the ‘A’ level. For example, when low and high levels of the second gate signal AG2 are about −6V and about 20V, respectively, low and high levels of the first gate signal AG1 are about −7V and about 25V, respectively.

In FIGS. 5 and 6, the data voltages of opposite polarity with reference to a common voltage VCOM are applied to the data lines adjacent to each other. Alternatively, the data voltages of the same polarity with reference to a common voltage VCOM may be applied to the data lines adjacent to each other. When data voltages of the same polarity are applied to the data lines adjacent to each other, charges of the first pixel electrode, which have been previously charged, repulse charges of the same polarity. Therefore, a difference between a low level and a high level of the second gate signal AG2 may be greater than a difference between a low level and a high level of the first gate signal AG1 in order to prevent the vertical flickering. For example when low and high levels of the second gate signal AG2 are about −7V and about 25V, respectively, low and high levels of the first gate signal AG1 are about −6V and about 20V, respectively.

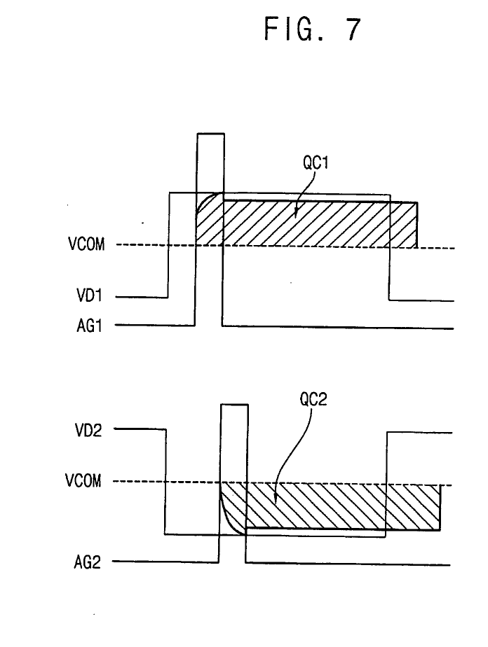

Hereinafter, charging quantity characteristics of data voltages that are charged in the first and second pixel sections PX1 and PX2 are described with reference to FIG. 7.

FIG. 7 is a waveform diagram illustrating charging quantity characteristics of exemplary data voltages in FIG. 5.

Referring to FIG. 7, when a first gate signal AG1 having a relatively high voltage gap is activated, the first data voltage VD1 is applied to the first pixel section PX1 to charge the first pixel section PX1.

Then, when the second gate signal AG2 having a relatively low voltage gap is subsequently activated, the second data voltage VD2, of which polarity is opposite to that of the first data voltage VD1, is applied to the second pixel section PX2 to charge the second pixel section PX2. The second pixel section PX2 is easily charged due to attractive force of the first pixel section PX1 because the second pixel section PX2 is charged with electrical charges having an opposite polarity to that of the first pixel section PX1. As a result, when the second gate signal AG2 of which voltage gap is smaller than that of the first gate signal AG1 is applied to the second pixel section PX2, a second charge quantity QC2 of the second pixel section PX2 becomes substantially the same as a first charge quantity QC1 of the first pixel section PX1. With the second charge quantity QC2 being substantially the same as the first charge quantity QC1, vertical flickering may be prevented.

Although not illustrated, it should be understood that the first and second charge quantities QC1 and QC2 may also be substantially the same in the exemplary embodiment where the first and second data voltages VD1 and VD2 have the same polarity and the second gate signal AG2 has a relatively higher voltage gap than the first gate signal AG1.

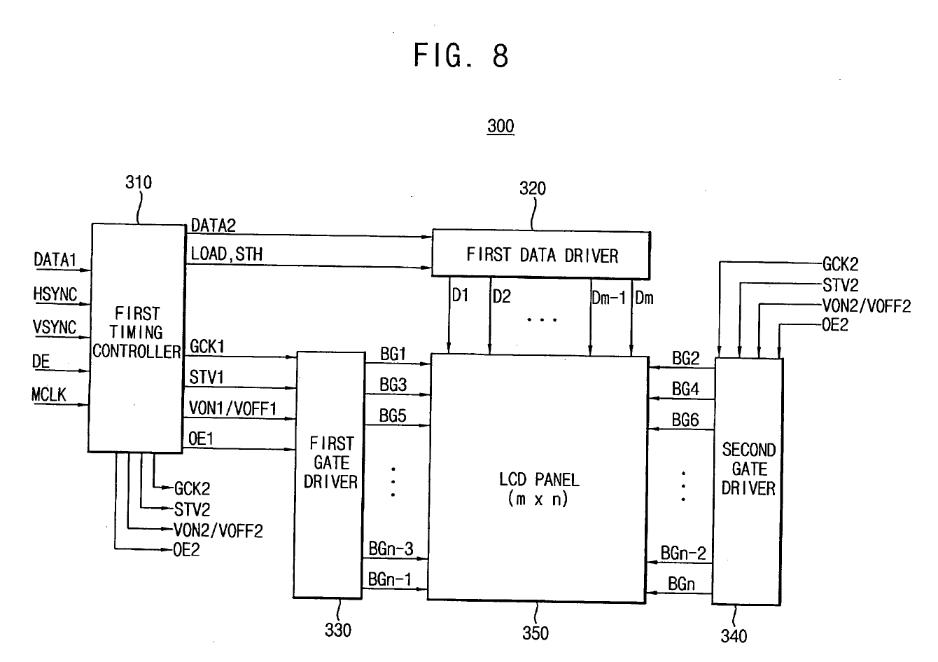

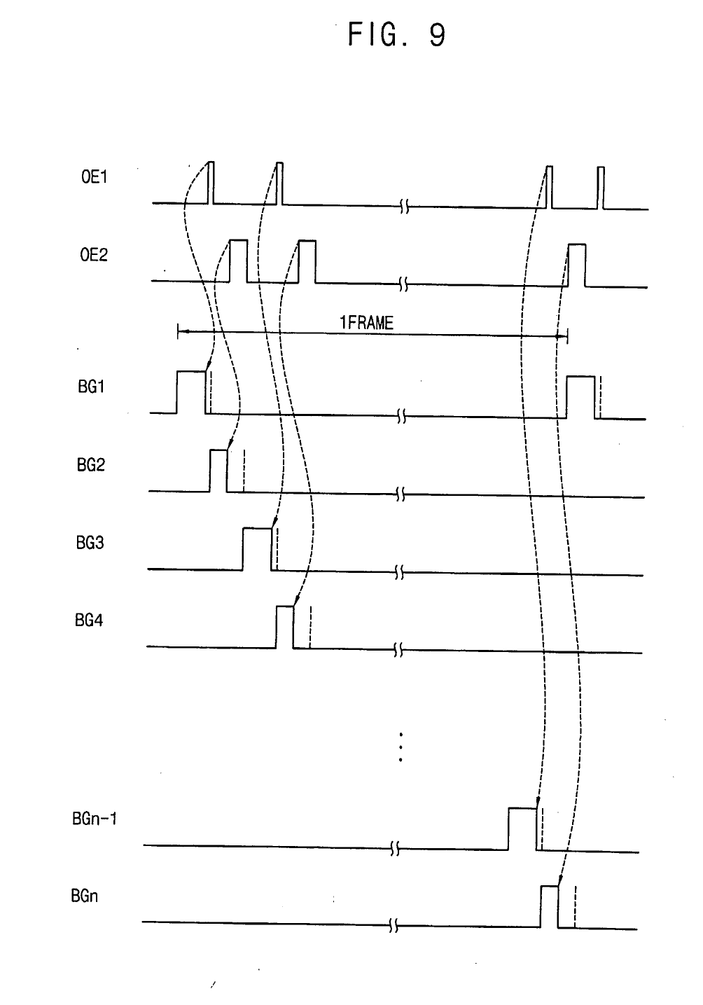

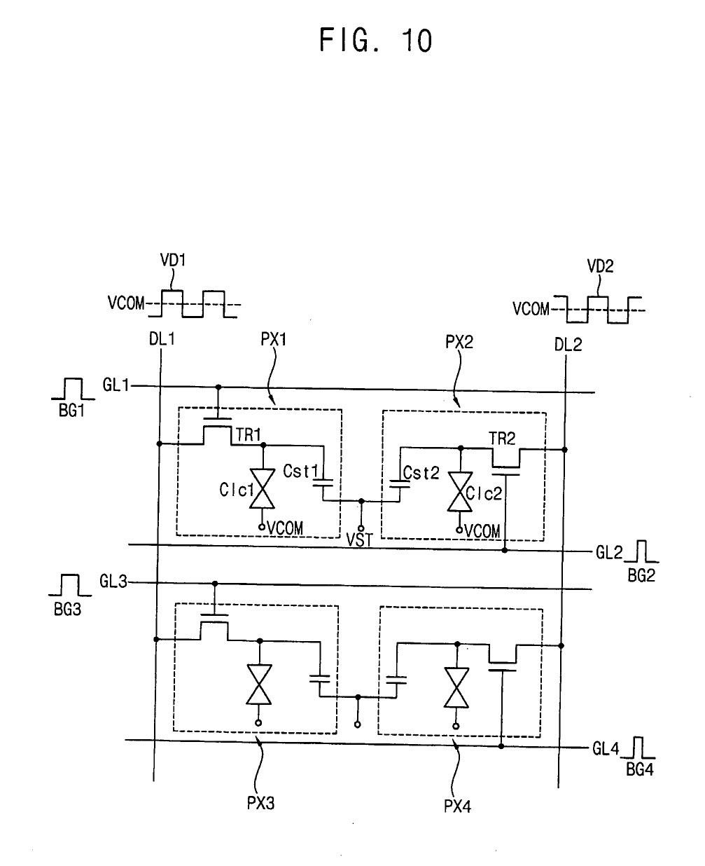

FIG. 8 is a block diagram illustrating an exemplary LCD device according to another exemplary embodiment of the present invention. FIG. 9 is a waveform diagram illustrating exemplary gate signals outputted from an exemplary first and second gate driver in FIG. 8.

Referring to FIGS. 8 and 9, an LCD device 300 includes a first timing controller 310, a first data driver 320, a first gate driver 330, a second gate driver 340 and an LCD panel 350.

The first timing controller 310 receives a first data signal DATA1, various synchronizing signals HSYNC and VSYNC, a data enable signal DE, and a main clock signal MCLK from an external device.

The first timing controller 310 outputs a second data signal DATA2 and a second data drive signal for outputting the second data signal DATA2 to the first data driver 320. The second data drive signal includes a load signal LOAD and a horizontal start signal STH. The first timing controller 310 outputs a first gate drive signal to the first gate driver 330, and outputs a second gate drive signal to the second gate driver 340. The first gate drive signal includes a first gate clock signal GCK1, a first vertical start signal STV1, and a first output enable signal OE1. The second gate drive signal includes a second gate clock signal GCK2, a first vertical start signal STV2, and a second output enable signal OE2.

A rising edge of the first vertical start signal STV1 and a rising edge of the second vertical start signal STV2 are separated by about 1 H time interval, or a falling edge of the first vertical start signal STV1 and a falling edge of the second vertical start signal STV2 are separated by a 1 H time interval. The first vertical start signal STV1 precedes the second vertical start signal STV2. Therefore, the second gate driver 340 is activated after the first gate driver 330 is activated.

The first and second output enable signals OE1 and OE2 have different pulse widths from each other. The first output enable signal OE1 controls each of the odd-numbered gate signals BG1, BG3, . . . , BGn-1, wherein ‘n’ represents an even number. In an exemplary embodiment, the first output enable signal OE1 controls each of the odd-numbered gate signals BG1, BG3, . . . , BGn-1 to have a relatively wide pulse width. In such an embodiment, the second output enable signal OE2 controls each of the even-numbered gate signals BG2, BG4, . . . , BGn-2 and BGn to have a relatively narrow pulse width.

When the second data signal DATA2 is transferred from the first timing controller 310 to the first data driver 320, the first data driver 320 changes the second data signal DATA2 into a data voltage that corresponds to a gray-scale voltage. Then, the first data driver 320 provides data lines of the LCD panel 350 with the changed data voltage D1, D2, . . . , Dm, wherein ‘m’ represents a positive number.

The first gate driver 330 sequentially provides odd-numbered gate lines of the LCD panel 350 with odd-numbered gate signals BG1, BG3, . . . , BGn-3 and BGn-1 activating the odd-numbered gate lines in response to the first gate drive signal GCK1 and STV1, wherein ‘n’ represents an even number.

The second gate driver 340 sequentially provides even-numbered gate lines of the LCD panel 350 with even-numbered gate signals BG2, BG4, . . . , BGn-2 and BGn in response to the second gate drive signal GCK2 and STV2. The even-numbered gate signals E3G2, BG4, . . . , BGn-2 and BGn activate the even-numbered gate lines of the LCD panel 350. The odd-numbered gate signals BG1, BG3, BGn-3 and BGn-1 and the even-numbered gate signals BG2, BG4, . . . , BGn-2 and BGn are alternately outputted to the LCD panel 350.

In one example, such as shown in FIG. 9, a pulse width of the odd-numbered gate signals BG1, BG3, . . . , BGn-3 and BGn-1 is relatively wider than a pulse width of the even-numbered gate signals BG2, BG4, . . . , BGn-2 and BGn. Charges applied to second pixel element sections corresponding to the even-numbered gate signals BG2, BG4, . . . , BGn-2 and BGn are opposite to charges previously stored in first pixel element sections corresponding to the odd-numbered gate signals BG1, BG3, . . . , BGn-3 and BGn-1. As a result, charges are easily stored in the second pixel element sections corresponding to the even-numbered gate signals BG2, BG4, . . . , BGn-2 and BGn. Therefore, a pulse width of the even-numbered gate signals BG2, BG4, . . . , BGn-2 and BGn is narrower than a pulse width of the odd-numbered gate signals BG1, BG3, . . . , BGn-3 and BGn-1.

On the contrary, although not illustrated, when charges applied to the second pixel element sections corresponding to the even-numbered gate signals BG2, BG4, . . . , BGn-2 and BGn are substantially the same as charges previously stored in first pixel element sections corresponding to the odd-numbered gate signals BG1, BG3, . . . , BGn-3 and BGn-1, such as by having the same polarity, the charges are not easily stored in the second pixel element sections corresponding to the even-numbered gate signals BG2, BG4, . . . , BGn-2 and BGn. Therefore, a pulse width of the even-numbered gate signals BG2, BG4, . . . , BGn-2 and BGn is wider than a pulse width of the odd-numbered gate signals BG1, BG3, . . . , BGn-3 and BGn-1.

The LCD panel 350 includes a plurality of gate lines (or scan lines) extending in a first direction that transfer a plurality of gate signals (or scan signals) BG1, BG2, . . . , BGn-1 and BGn, and a plurality of data lines (or source lines), extending in a second direction substantially perpendicular to the first direction, transfer a plurality of data voltages D1, D2, . . . , Dm. The LCD panel 350 has the half-reduced data line structure. The half-reduced data line structure includes an increased number of gate lines and a decreased number of data lines. The half-reduced data line structure is described in FIGS. 3 and 4.

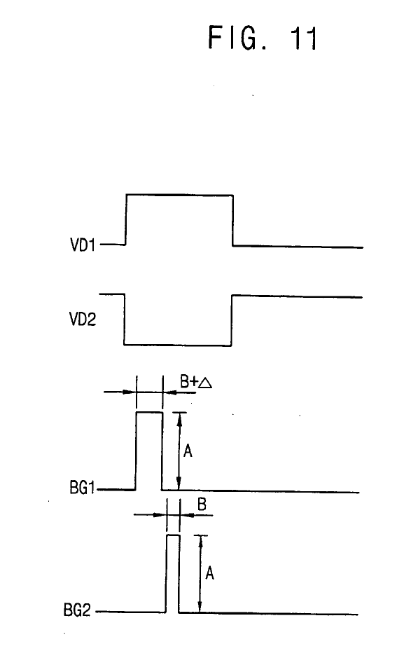

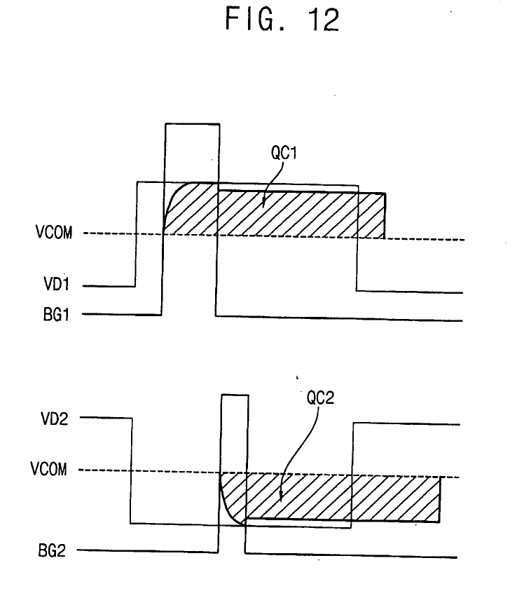

FIG. 10 is a circuit diagram illustrating an exemplary pixel element section of the exemplary LCD device in FIG. 8. FIG. 11 is a waveform diagram illustrating exemplary gate voltages and exemplary data voltages in FIG. 10. The LCD device of the present embodiment is substantially the same as in FIG. 5. Thus, the same reference numerals will be used to refer to the same or like sections as those described in FIG. 5 and any further explanation concerning the above elements will be omitted.

Referring to FIGS. 10 and 11, the first data voltage VD1 that is applied to the first data line DL1 is charged in the first pixel section PX1 through the first gate signal BG1.

The first data voltage VD1 has a positive polarity with reference to a common voltage VCOM. The first gate signal BG1 is applied to the first gate line GL1, so that the first TFT TR1, which is electrically connected to the first gate line GL1, is activated. The first data voltage VD1 is charged in a first liquid crystal capacitor Clc1 and a first storage capacitor Cst1 through the first TFT TR1. A second liquid crystal capacitor Clc2 and a second storage capacitor Cst2 are electrically connected to each other. A first terminal of the first storage capacitor Cst1 is electrically connected to a drain electrode of the first TFT TR1, and a second terminal of the first storage capacitor Cst1 is electrically connected to the VST terminal.

The second data voltage VD2 that is applied to the second data line DL2 is charged in the second pixel section PX2 in response to the second gate signal BG2. The second data voltage VD2 has a negative polarity with reference to a common voltage VCOM. The second gate signal BG2 is applied to the second gate line GL2, so that the second TFT TR2, which is electrically connected to the second gate line GL2, is activated. The second data voltage VD2 is charged in the second liquid crystal capacitor Clc2 and the second storage capacitor Cst2 through the second TFT TR2. The second liquid crystal capacitor Clc2 and the second storage capacitor Cst2 are electrically connected to each other. A first terminal of the second storage capacitor Cst2 is electrically connected to a drain electrode of the second TFT TR2, and a second terminal of the second storage capacitor Cst2 is electrically connected to the VST terminal.

For example, as shown in FIG. 11, a pulse width of the second gate signal BG2 is substantially equal to a turn-on voltage of the second TFT TR2, while a pulse width of the first gate signal BG1 is relatively wider than a pulse width of the second gate signal BG2. The pulse width of the first gate signal BG1 is controlled by the first output enable signal OE1. The pulse width of the second gate signal BG2 is controlled by the second output enable signal OE2.

In FIGS. 10 and 11, the data voltages of opposite polarity with reference to a common voltage VCOM are applied to the data lines adjacent to each other. However, in an alternative embodiment, the data voltages of the same polarity with reference to a common voltage VCOM may be applied to the data lines adjacent to each other. When data voltages of the same polarity are applied to the data lines adjacent to each other, charges of the first pixel electrode, which have been previously charged, repulse charges of the same polarity. Therefore, a pulse width of the second gate signal BG2 is greater than a pulse width of the first gate signal BG1 in order to prevent the vertical flickering.

Hereinafter, charging quantity characteristics of data voltages that are charged in the first and second pixel sections PX1 and PX2 are described with respect to FIG. 12.

FIG. 12 is a waveform diagram illustrating charging quantity characteristics of data voltages in FIG. 10.

Referring to FIG. 12, when the first gate signal BG1 having a relatively wide pulse width is activated, the first data voltage VD1 is applied to the first pixel section PX1 to charge the first pixel section PX1.

Then, when the second gate signal BG2 having a relatively narrow pulse width is activated, the second data voltage VD2, of which polarity is opposite to that of the first data voltage VD1, is applied to the second pixel section PX2 to charge the second pixel section PX2. The second pixel section PX2 is easily charged due to an attractive force of the first pixel section PX1 because the second pixel section PX2 is charged with electrical charges having an opposite polarity to that of the first pixel section PX1.

As a result, when the second gate signal BG2 of which a pulse width is narrower than that of the first gate signal BG1 is applied to the second pixel section PX2, a second charge quantity QC2 of the second pixel section PX2 becomes substantially the same as a first charge quantity QC1 of the first pixel section PX1. As a result, the vertical flickering may be prevented.

Although not illustrated, it should be understood that the first and second charge quantities QC1 and QC2 may also be substantially the same in the exemplary embodiment where the first and second data voltages VD1 and VD2 have the same polarity and the second gate signal BG2 has a relatively wider pulse width than the first gate signal BG1.

As described above, according to the LCD device and the method of driving the LCD device, in driving of the LCD device having a half-reduced data line structure, a relatively pre-charged first pixel performs a charging operation in response to a gate signal of a relatively higher level or a gate signal of a relatively wide pulse width. Alternatively, a relatively post-charged second pixel performs a charging operation in response to a gate signal of an ordinary level or a gate signal of an ordinary wide pulse width. Therefore, a vertical flickering may be prevented.

Although the exemplary embodiments of the present invention have been described, it is understood that the present invention should not be limited to these example embodiments but various changes and modifications can be made by one ordinary skilled in the art within the spirit and scope of the present invention as hereinafter claimed.

What is claimed is:

1. A liquid crystal display device comprising:
a liquid crystal display panel having a first pixel section and a second pixel section formed in regions defined by a plurality of gate lines adjacent to each other and a plurality of data lines adjacent to each other, the first pixel section electrically charged at a first time point, and the second pixel section electrically charged at a second time point later than the first time point;
a data driver providing the data lines with data voltages; and
a gate driver applying a first gate signal to the first pixel section, and a second gate signal, having at least one different characteristic from that of the first gate signal, to the second pixel section.

2. The liquid crystal display device of claim 1, wherein the data driver applies a first data signal to the first pixel section, and applies a second data signal having an opposite polarity to that of the first data signal to the second pixel section.

3. The liquid crystal display device of claim 2, wherein an amplitude of the first gate signal is greater than an amplitude of the second gate signal.

4. The liquid crystal display device of claim 2, wherein a pulse width of the first gate signal is wider than a pulse width of the second gate signal.

5. The liquid crystal display device of claim 1, wherein the data driver applies a first data signal to the first pixel section, and applies a second data signal having a same polarity as that of the first data signal to the second pixel section.

6. The liquid crystal display device of claim 5, wherein an amplitude of the first gate signal is smaller than an amplitude of the second gate signal.

7. The liquid crystal display device of claim 5, wherein a pulse width of the first gate signal is narrower than a pulse width of the second gate signal.

8. The liquid crystal display device of claim 1, wherein the first pixel section comprises a first switching element and a first liquid crystal capacitor electrically connected to the first switching element,
the second pixel section comprises a second switching element and a second liquid crystal capacitor electrically connected to the second switching element, and
each of the first and second pixel sections are commonly connected to a storage capacitor.

9. The liquid crystal display device of claim 1, wherein the gate driver comprises:
a first gate driver outputting the first gate signal having a first level to a gate line electrically connected to the first pixel section in response to a first gate-on voltage; and
a second gate driver outputting the second gate signal having a second level to a gate line electrically connected to the second pixel section in response to a second gate-on voltage.

10. The liquid crystal display device of claim 9, further comprising:
a timing controller outputting the first gate-on voltage and the second gate-on voltage to the first gate driver and the second gate driver, respectively.

11. The liquid crystal display device of claim 9, wherein the first level is higher than the second level.

12. The liquid crystal display device of claim 9, wherein the first gate driver is activated by a first vertical start signal and the second gate driver is activated by a second vertical start signal different from the first vertical start signal.

13. The liquid crystal display device of claim 12, wherein each of the vertical start signals is separated by a 1 H time interval.

14. The liquid crystal display device of claim 1, wherein the gate driver comprises:
a first gate driver outputting the first gate signal having a first pulse width to a gate line electrically connected to the first pixel section in response to a first output enable signal; and
a second gate driver outputting the second gate signal having a second pulse width to a gate line electrically connected to the second pixel section in response to a second output enable signal.

15. The liquid crystal display device of claim 14, wherein the first pulse width is relatively wider than the second pulse width.

16. The liquid crystal display device of claim 14, wherein the first gate driver is activated by a first vertical start signal and the second gate driver is activated by a second vertical start signal, different from the first vertical start signal.

17. The liquid crystal display device of claim 16, wherein the vertical start signals are separated by a 1 H time interval.

18. The liquid crystal display device of claim 14, further comprising a timing controller outputting the first output enable signal and the second output enable signal to the first gate driver and the second gate driver, respectively.

19. The liquid crystal display device of claim 1, wherein a first charge quantity of the first pixel section is substantially same as a second charge quantity of the second pixel section.

20. A method of driving a liquid crystal display device having a liquid crystal display panel with a first pixel section and a second pixel section formed in regions defined by a plurality of gate lines adjacent to each other and a plurality of data lines adjacent to each other, the method comprising:
applying data voltages to the data lines;
applying a first gate signal to a gate line electrically connected to the first pixel section; and
applying a second gate signal, having at least one different characteristic from that of the first gate signal, to a gate line electrically connected to the second pixel section after the first gate signal is applied to the gate line electrically connected to the first pixel section.

21. The method of claim 20, wherein applying data voltages to the data lines comprises:
applying a first data signal to the first pixel section; and
applying a second data signal, having an opposite polarity to that of the first data signal, to the second pixel section.

22. The method of claim 21, wherein applying a second gate signal includes applying the second gate signal having an amplitude less than an amplitude of the first gate signal to the gate line electrically connected to the second pixel section.

23. The method of claim 21, wherein applying a second gate signal includes applying the second gate signal having a pulse width less than a pulse width of the first gate signal to the gate line electrically connected to the second pixel section.

24. The method of claim 20, wherein applying data voltages to the data lines comprises:
applying a first data signal to the first pixel section; and
applying a second data signal, having a same polarity as that of the first data signal, to the second pixel section.

25. The method of claim 24, wherein applying a second gate signal includes applying the second gate signal having an amplitude greater than an amplitude of the first gate signal to the gate line electrically connected to the second pixel section.

26. The method of claim 24, wherein applying a second gate signal includes applying the second gate signal having a pulse width greater than a pulse width of the first gate signal to the gate line electrically connected to the second pixel section.

27. The method of claim 20, wherein applying the first and second gate signals includes providing a level of the first gate signal higher than that of the second gate signal.

28. The method of claim 27, further comprising defining the first gate signal by a first gate-on voltage and a first gate-off voltage, and defining the second gate signal by a second gate-on voltage and a second gate-off voltage different from the first gate-on voltage and the first gate-off voltage.

29. The method of claim 27, wherein comprising defining the first gate signal by a first gate-on voltage and a first gate-off voltage, and defining the second gate signal by a second gate-on voltage different than the first gate-on voltage and a second gate-off voltage substantially the same as the first gate-off voltage.

30. The method of claim 20, wherein applying a first gate signal includes applying a first gate signal having a pulse width wider than a pulse width of the second gate signal.
